(19) United States
(12) Patent Application Publication
(10) Pub. No.: US 2009/0146393 A1
(43) Pub. Date: Jun. 11, 2009

(54) Guide it

(76) Inventors: Edward Wayne Hawkins, Pensacola, FL (US); Deborah Hawkins Knight, Pensacola, FL (US)

Correspondence Address: Edward W. Hawkins, 300 Lakewood Rd., Pensacola, FL, 32507, US

(21) Appl. No.: 11/999,598

(22) Filed: Dec. 6, 2007

(51) Int. Cl. B60R 1/06

(52) U.S. Cl. 280/477

(57) ABSTRACT

A mirror is mounted on the tailgate of a truck and is oriented to reflect the tailgate target to the rear view mirror of the truck whereby a driver can align a trailer and the tailgate.

### TECHNICAL FIELD OF THE INVENTION

The present invention relates to the general art of automobiles, and to the particular field of accessories for automobiles.

### BACKGROUND OF THE INVENTION

A trailer is typically attached to a towing vehicle using a trailer hitch. The trailer hitch includes a ball mounted on the rear of the vehicle to which a coupling on the trailer is secured. Aligning the trailer hitch ball with the trailer coupling, however, has always been cumbersome and difficult, especially for an unassisted driver. Typically, the driver reverses the vehicle towards the trailer while attempting to observe the trailer coupling and ball in the rear or side view mirror. However, because of the position and size of the mirrors, the trailer hitch ball or coupling is not always visible requiring the driver to reverse and advance the vehicle repeatedly before successfully maneuvering the ball in the vicinity of the coupling. Even once both components are visible, the driver's depth perception is hindered such that the towing vehicle often collides with the trailer. At best, the driver is able to position the trailer hitch ball within a few feet of the trailer coupling eventually requiring the driver to manually move the trailer until the coupling is properly positioned over the ball. The present invention provides a device that assists a driver in positioning the trailer hitch ball immediately beneath the trailer coupling.

### SUMMARY OF THE INVENTION

These, and other, objects are achieved by a mirror that is mounted on the tailgate of a truck and is oriented to reflect the tailgate target to the rear view mirror of the truck whereby a driver can align a trailer and the tailgate.

### BRIEF DESCRIPTION OF THE DRAWING FIGURES

FIG. 1 is a perspective view of an alignment mirror embodying the present invention.

FIG. 2 is a sectional view taken along line A-A of FIG. 1.

FIG. 3 shows a detail of FIG. 1.

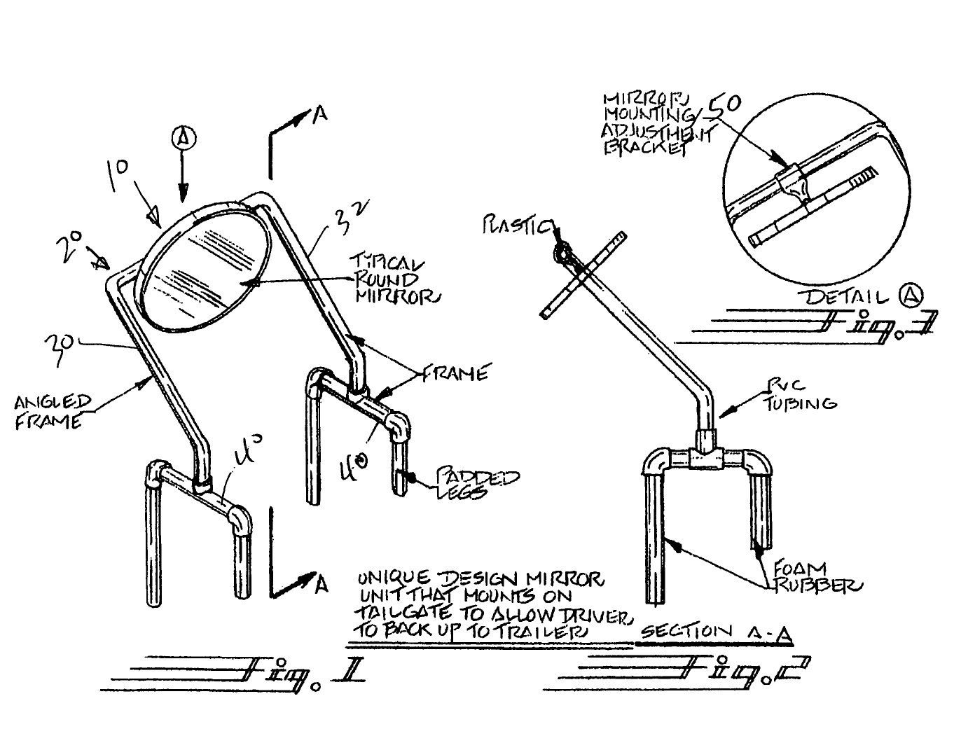

### DETAILED DESCRIPTION OF THE PREFERRED EMBODIMENT OF THE INVENTION

Other objects, features and advantages of the invention will become apparent from a consideration of the following detailed description and the accompanying drawings.

Referring to the figures, it can be understood that the present invention is embodied in mirror 10 which is mounted on a tailgate of a truck by a mount 20. Mount 20 includes an two angled frames 30 and 32 each fixed to a U-shaped leg unit 40 which is mounted on the tailgate so the driver will have a view of the tailgate in the rear view mirror of the vehicle. An adjustment bracket 50 is used to properly orient the mirror.

It is understood that while certain forms of the present invention have been illustrated and described herein, it is not to be limited to the specific forms or arrangements of parts described and shown.

I claim:

1. An alignment aid made with pvc tubing with a mirror mounted on a truck tailgate, that mirror being oriented on such tailgate to reflect the tailgate target to the rearview mirror of the truck, whereby a driver can align a trailer and towing vehicle hitch. Adjustable mirror is attached to pvc frame with four padded legs to sit on top of truck tailgate.
